(19) United States
(12) Patent Application Publication
(10) Pub. No.: US 2026/0230800 A1
(43) Pub. Date: Aug. 6, 2026

(54) TERMINAL APPARATUS, CONTROL METHOD, AND STORAGE MEDIUM IN WIRELESS COMMUNICATION SYSTEM IN WHICH RELAY DEVICE IS USED AS EXTENDED ANTENNA OF TERMINAL APPARATUS

(71) Applicant: KDDI CORPORATION, Tokyo (JP)

(72) Inventors: Taishi WATANABE, Fujimino-shi (JP); Takeo OHSEKI, Fujimino-shi (JP); Issei KANNO, Fujimino-shi (JP)

(21) Appl. No.: 19/559,356

(22) Filed: Mar. 6, 2026

Related U.S. Application Data
(63) Continuation of application No. PCT/JP2024/005145, filed on Feb. 15, 2024.

(30) Foreign Application Priority Data
Sep. 21, 2023 (JP) 2023-156513

(51) Int. Cl. H04W 8/22; H04B 7/06; H04W 24/10; H04W 76/25

(52) U.S. Cl. CPC H04W 8/22; H04B 7/0626; H04B 7/0658; H04W 24/10; H04W 76/25

(57) ABSTRACT

A terminal apparatus for connecting to a base station apparatus determines a need to change capability information notified to the base station apparatus, transmits to the base station apparatus, in response to determining that the capability information needs to be changed, a signal for transmission of the capability information to the base station apparatus in a state where no inquiry about the capability information is received from the base station apparatus while connection with the base station apparatus is maintained, and notifies the base station apparatus of the changed capability information.

### CROSS-REFERENCE TO RELATED APPLICATION(S

This application is a continuation of International Patent Application No. PCT/JP2024/005145 filed on February 15, 2024, which claims priority to and the benefit of Japanese Patent Application No. 2023-156513 filed on September 21, 2023, the entire disclosures of which are incorporated herein by reference.

### BACKGROUND OF THE INVENTION

### Field of the Invention

The present invention relates to a wireless communication system in which a relay device is used as an extended antenna of a terminal apparatus.

### Description of the Related Art

As a technology directed to a sixth-generation cellular communication system, a technology is being studied in which a relay device having a relay function at a radio frequency (RF) is used as an extended antenna capable of beamforming (see K. Yamazaki, T. Ohseki, Y. Amano, H. Shinbo, T. Murakami, and Y. Kishi, “Proposal for a User-Centric Ran Architecture Towards Beyond 5G”, 2021 ITU Kaleidoscope: Connecting Physical and Virtual Worlds (ITU K), February 2021).

K. Yamazaki, T. Ohseki, Y. Amano, H. Shinbo, T. Murakami, and Y. Kishi, “Proposal for a User-Centric Ran Architecture Towards Beyond 5G”, 2021 ITU Kaleidoscope: Connecting Physical and Virtual Worlds (ITU K), February 2021 is an example of prior art.

There has not been progress in studying specific methods for using the relay device as described above as an extended antenna in a cellular communication system.

### SUMMARY OF THE INVENTION

The present invention provides a control technology for a terminal apparatus to communicate with a base station apparatus with use of a relay device having an RF relay function as an extended antenna.

According to one aspect of the present invention, there is provided a terminal apparatus for connecting to a base station apparatus, comprising: a determination unit configured to determine a need to change capability information notified to the base station apparatus; a transmission unit configured to, in response to determining that the capability information needs to be changed, transmit, to the base station apparatus, a signal for transmission of the capability information to the base station apparatus in a state where no inquiry about the capability information is received from the base station apparatus while connection with the base station apparatus is maintained; and a notification unit configured to notify the base station apparatus of the changed capability information.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating an example of a configuration of a wireless communication system.

FIG. 2 is a diagram illustrating an example of a flow of processing in which a terminal apparatus acquires capability information of a relay device.

FIG. 3A is a diagram showing an example of a flow of processing in which the terminal apparatus actively notifies a base station apparatus of capability information.

FIG. 3B is a diagram showing an example of a flow of processing in which the terminal apparatus actively notifies the base station apparatus of capability information.

FIG. 4 is a diagram showing an example of a flow of processing in which the terminal apparatus specifies a detailed state of a transmission path between the terminal apparatus, the base station apparatus, and the relay device.

FIG. 5 is a diagram illustrating an aspect of a configuration of a relay device that converts a frequency of a signal received from the terminal apparatus into one of a plurality of frequencies.

FIG. 6 is a diagram illustrating an example of a flow of processing for controlling a conversion destination of a frequency of a radio signal in the relay device.

FIG. 7 is a diagram illustrating an example of a flow of processing in which the terminal apparatus detects a relay device that has only a relay function.

FIG. 8 is a diagram illustrating an example of a hardware configuration of part of the terminal apparatus and the relay device.

FIG. 9 is a diagram illustrating an example of a functional configuration of the terminal apparatus.

FIG. 10 is a diagram illustrating an example of a functional configuration of part of the relay device.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

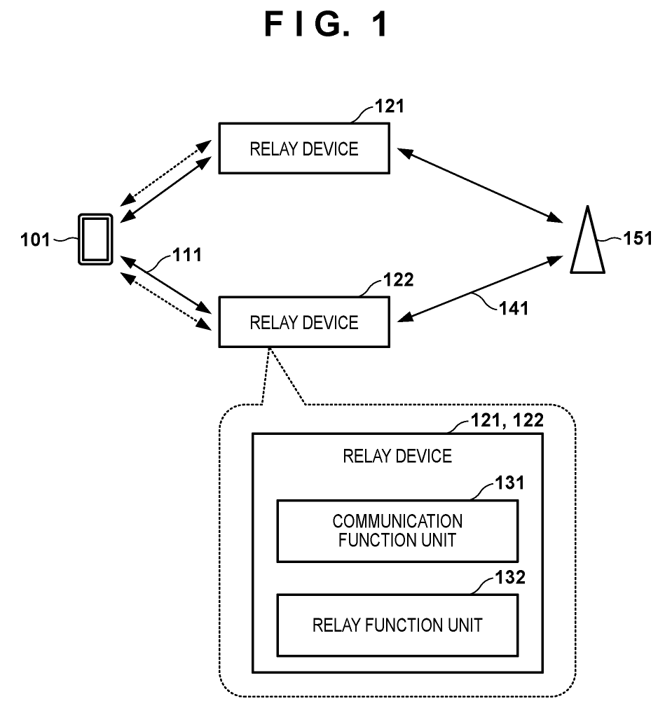

FIG. 1 shows an example of a configuration of a wireless communication system according to the present embodiment. In this wireless communication system, a terminal apparatus 101 is connected to a plurality of relay devices 121 and 122, and the relay devices 121 and 122 relay communication between the terminal apparatus 101 and a base station apparatus 151. The terminal apparatus 101 and the base station apparatus 151 are, for example, wireless communication apparatuses that comply with fifth-generation (5G) or later cellular communication standards of the 3rd Generation Partnership Project (3GPP (registered trademark)). Note that although FIG. 1 shows an example in which there is one terminal apparatus 101 and one base station apparatus 151, it is naturally envisioned that there are many of these communication apparatuses.

In this embodiment, the relay devices 121 and 122 are connected to the terminal apparatus 101 and relay only communication involving the terminal apparatus 101, and thereby operate so as to function as virtual antennas extended from the terminal apparatus 101. That is, the relay devices 121 and 122 function as protruding antennas (extended antennas) of the terminal apparatus 101, and are configured to use radio instead of cables with the terminal apparatus 101 at that time. As a result, the terminal apparatus 101 communicates with the base station apparatus 151 with use of the relay devices 121 and 122 as antennas provided in the terminal apparatus 101 itself. Note that the base station apparatus 151 does not recognize the relay devices 121 and 122 individually. That is, the terminal apparatus 101 and the relay devices 121 and 122 are combined to operate as a virtual terminal apparatus. Hereinafter, since the relay devices 121 and 122 function as antennas of a virtual terminal apparatus, these devices are referred to as virtual antennas in some cases. To be more precise, each of the one or more antennas possessed by the relay devices 121 and 122 is used as a virtual antenna, but when there is no particular need to distinguish between them, the relay devices 121 and 122 that perform relay transmission are referred to as virtual antennas (the relay devices 121 and 122 are said to function as virtual antennas) in some cases. The relay devices 121 and 122 are configured to relay only communication involving the terminal apparatus 101, and do not relay communication of another terminal apparatus. The relay devices 121 and 122 can be, for example, wireless devices held by a user, such as smart watches, but there is no particular limitation thereto.

The relay devices 121 and 122 amplify a radio signal transmitted from the terminal apparatus 101 and relay the result to the base station apparatus 151, and amplify a radio signal transmitted from the base station apparatus 151 and relay the result to the terminal apparatus 101. Note that the relay devices 121 and 122 do not demodulate or decode the radio signals transmitted and received between the terminal apparatus 101 and the base station apparatus 151. That is, the relay devices 121 and 122 have a radio frequency (RF) relay function (function as radio repeaters). Here, a signal 111 transmitted and received between the terminal apparatus 101 and the relay devices 121 and 122 is transmitted over a short-distance communication line using, for example, a high frequency band (terahertz (THz) band) such as the 300 GHz band. On the other hand, the signal 141 transmitted and received between the relay devices 121 and 122 and the base station apparatus 151 is transmitted over a relatively long-distance communication line using, for example, a relatively low frequency band (millimeter-wave band) such as the 39 GHz band. That is, the relay devices 121 and 122 convert a signal received in a first frequency band (THz band) for communication with the terminal apparatus 101 into a second frequency band (millimeter-wave band) for communication with the base station apparatus 151 and relay the resulting signal, and convert a signal received in the second frequency band into the first frequency band and relay the resulting signal.

As radio repeaters, the relay devices 121 and 122 perform only amplification and frequency conversion for communication between the terminal apparatus 101 and the base station apparatus 151, but also have a communication function for accepting control from the terminal apparatus 101. Note that in this embodiment, it is assumed that the relay devices 121 and 122 function as radio repeaters, but the following discussion may also be applied, as necessary, to a case where the relay devices are configured to perform regenerative relay. As shown in FIG. 1, for example, the relay devices 121 and 122 each include a communication function unit 131 that is a communication function for accepting control from the terminal apparatus 101, and a relay function unit 132. The communication function unit 131 has a function of performing sidelink communication with the terminal apparatus 101 in accordance with the 3GPP cellular communication standard, for example. Note that this is an example, and the communication function unit 131 may also be configured to communicate with the terminal apparatus 101 using, for example, a communication function such as a wireless local area network (LAN) or Bluetooth (registered trademark). The terminal apparatus 101 uses, for example, a sidelink communication function to discover the relay devices 121 and 122 that perform communication using the communication function units 131, and the terminal apparatus 101 connects to the relay devices 121 and 122 through communication with the communication function units 131.

The relay function unit 132 has a radio repeater function of performing amplification and frequency conversion on a signal received from the terminal apparatus 101 or the base station apparatus 151, and outputting the signal resulting from amplification and frequency conversion. Note that the relay function unit 132 can operate in a frequency band different from that of the communication function unit 131. For example, the terminal apparatus 101 can be configured to perform communication for controlling the relay devices 121 and 122 in a relatively low predetermined frequency band, and to execute communication with the base station apparatus 151 via the relay devices 121 and 122 in a high frequency band such as the THz band or millimeter-wave band. Note that this is an example, and the communication function unit 131 may also use the frequency band used by the relay function unit 132, such as the THz band or millimeter-wave band, for example. The communication function unit 131 and the relay function unit 132 are each configured to operate in a frequency band corresponding to the operation of the terminal apparatus 101. Note that the terminal apparatus 101 performs only control communication with the relay devices 121 and 122. In addition, by using the relay devices 121 and 122 that are located at a short distance from the terminal apparatus 101, the terminal apparatus 101 does not need to transmit signals to the base station apparatus 151 at high power, and therefore power consumption can be suppressed.

Hereinafter, various types of information to be transmitted and received between the terminal apparatus 101, the relay devices 121 and 122, and the base station apparatus 151 in the present embodiment, and the various processes to be executed will be described under the premise that such a system configuration is used.

### Acquisition of Capability Information Regarding Radio Repeater Portion of Relay Device

As described above, the terminal apparatus 101 can execute control communication to control the relay devices 121 and 122, but at that time, it needs to recognize the capabilities of the relay devices 121 and 122. In particular, it is important for the terminal apparatus 101 to recognize the relay communication function in the relay function unit 132 for communication with the base station apparatus 151. In the present embodiment, in consideration of such circumstances, the relay devices 121 and 122 each use the communication function unit 131 to notify the terminal apparatus 101 of capability information related to the relay function unit 132. For example, the relay devices 121 and 122 transmit, as capability information, information indicating whether or not they have the relay function units 132 to the terminal apparatus 101. In addition, the relay devices 121 and 122 may transmit, as capability information, information indicating whether or not the relay function units 132 can function as virtual antennas of the terminal apparatus 101 to the terminal apparatus 101. By acquiring this information, the terminal apparatus 101 becomes able to search for relay devices that can be used as virtual antennas.

In addition, the relay devices 121 and 122 can notify the terminal apparatus 101 of, for example, information indicating frequency bands that can be used on the terminal apparatus 101 side as capability information. That is, the relay devices 121 and 122, as radio repeaters, can notify the terminal apparatus 101 of information on a first frequency band (e.g., the THz band) to which the radio signal transmitted from the base station apparatus 151 is converted when being relayed to the terminal apparatus 101. For example, the terminal apparatus 101 can determine that the relay devices 121 and 122 can be used as virtual antennas on the condition that the frequency band usable by the terminal apparatus 101 itself and the frequency band usable by the relay devices 121 and 122 match. In addition, the relay devices 121 and 122 can notify the terminal apparatus 101 of, for example, information indicating a second frequency band (e.g., a millimeter-wave band) that can be used for transmitting and receiving signals to and from the base station apparatus 151 as capability information. For example, the terminal apparatus 101 can determine that the relay devices 121 and 122 can be used as virtual antennas on the condition that the frequency band usable by the base station apparatus 151 and the frequency band usable by the relay devices 121 and 122 on the base station apparatus 151 side match. Note that these frequency bands may be notified to the terminal apparatus 101 as, for example, a list of frequency bands usable by the relay function unit 132. The terminal apparatus 101 can specify the frequency band to be used in communication that the terminal apparatus 101 performs using the relay devices 121 and 122 by acquiring information on frequency bands supported by the relay function units 132 in the relay devices 121 and 122. Note that the relay devices 121 and 122 can notify the terminal apparatus 101 of information on at least one of the first frequency band and the second frequency band. That is, the relay devices 121 and 122 do not necessarily need to notify the terminal apparatus 101 of information on both the first frequency band and the second frequency band, and may notify the terminal apparatus 101 of only information on either the first frequency band or the second frequency band.

In addition, the relay devices 121 and 122 may notify the terminal apparatus 101 of the number and configuration of physical antennas that are usable in the relay function units 132 as capability information. The information on the number of antennas can include, for example, information on the number of antennas that are usable as antennas on the terminal apparatus 101 side and the number of antennas that are usable as antennas on the base station apparatus 151 side. The information on the number of antennas may also include, for example, information indicating the number of antennas corresponding to each frequency band that is usable by the relay devices 121 and 122. The information on the configuration of the antennas may include information on a positional relationship in which the antennas are arranged. The information on the configuration of the antennas may also include information on the number of streams that can be transmitted and received to and from the base station apparatus 151, and the like. Based on this information, the terminal apparatus 101 can transmit a plurality of streams to the relay devices 121 and 122 using, for example, polarization or a plurality of frequency bands. The relay devices 121 and 122 can separate the plurality of streams by polarization or frequency band, and can transmit the plurality of streams in parallel using a plurality of antennas (and a plurality of frequency bands as necessary) on the base station apparatus 151 side. In this way, based on the information on the number and configuration of antennas, the terminal apparatus 101 can specify the format in which communication can be performed via the relay devices 121 and 122.

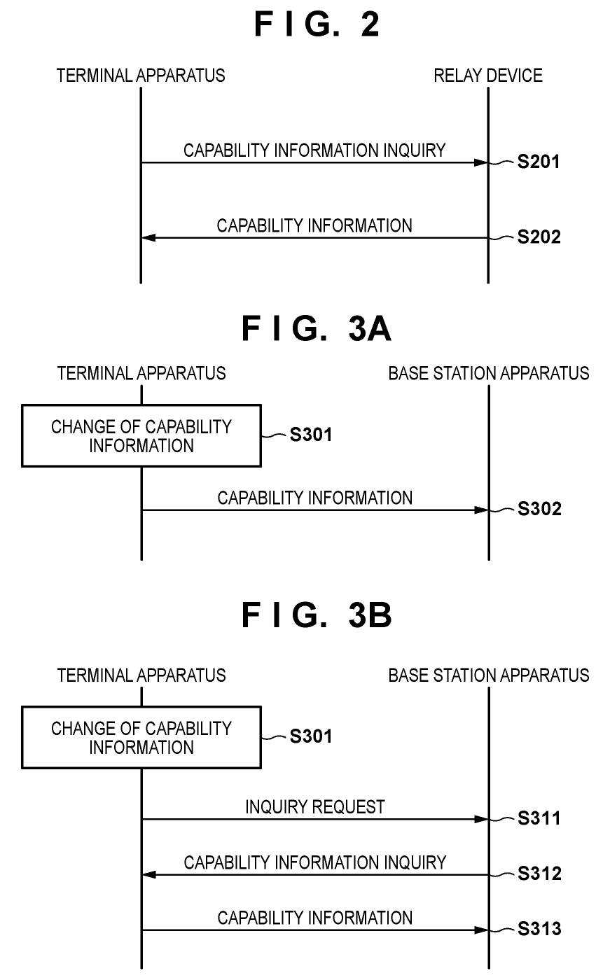

FIG. 2 shows an example of a flow of processing performed when the capability information of the relay devices 121 and 122 is provided to the terminal apparatus 101. The terminal apparatus 101 transmits, for example, a message inquiring about capability information to each of the relay devices 121 and 122 (step S201), and each of the relay devices 121 and 122 provides its own capability information to the terminal apparatus 101 (step S202). Note that the terminal apparatus 101 may also transmit an inquiry message including information indicating whether or not the terminal apparatus 101 itself is a terminal apparatus that can use a virtual antenna. If the terminal apparatus 101 is capable of using a virtual antenna, the relay devices 121 and 122 may notify the terminal apparatus 101 of information indicating whether the relay devices 121 and 122 have a function as a virtual antenna. In addition, the terminal apparatus 101 may transmit an inquiry message including information on a frequency band (e.g., the THz band) that is usable by the terminal apparatus 101 with a relay device that functions as a virtual antenna. In addition, the terminal apparatus 101 may transmit an inquiry message including information on the frequency band that the base station apparatus 151 uses for communication. In these cases, as the capability information, the relay devices 121 and 122 may notify the terminal apparatus 101 of information on the frequency bands that are usable by the relay devices 121 and 122, or information indicating whether or not the frequency band included in the inquiry message is usable. In addition, the terminal apparatus 101 may transmit an inquiry message including information on the number and configuration of antennas that the terminal apparatus 101 has. As described above, the relay devices 121 and 122 notify the terminal apparatus 101 of the number and configuration of antennas that the relay devices 121 and 122 have as the capability information.

Note that the terminal apparatus 101 can acquire capability information related to the radio repeater portions (relay function units 132) from the relay devices 121 and 122 using, for example, regulations related to sidelink communication in the 3GPP standard. In this case, the communication function units 131 of the relay devices 121 and 122 are configured to operate in accordance with the sidelink communication regulations. In this case, for example, capability information for sidelink communication can be reused. In sidelink communication, a terminal apparatus transmits a UECapabilityEnquirySidelink message inquiring about acquisition of capability information of another terminal apparatus, and the other terminal apparatus transmits a UECapabilityinformationSidelink message including the capability information of the other terminal apparatus. For example, in the above-described step S201, the terminal apparatus 101 transmits a first message that is an extension of the UECapabilityEnquirySidelink message to the relay devices 121 and 122. Then, when the communication function units 131 of the relay devices 121 and 122 receive the message that is an extension of the UECapabilityEnquirySidelink message, in the above-mentioned step S202, the message that is an extension of the UECapabilityinformationSidelink message can be used to transmit capability information regarding the radio repeater portions (relay function units 132) to the terminal apparatus 101.

The terminal apparatus 101 can transmit, to the relay devices 121 and 122, information indicating an inquiry about capability information related to the radio repeater portion in a message that is an extension of the UECapabilityEnquirySidelink message. This message can also include information inquiring about whether the relay devices 121 and 122 have the function as a radio repeater (whether they are capable of operating as a virtual antenna). Note that the conventional UECapabilityEnquirySidelink message includes a frequencyBandListFilterSidelink that inquires about frequency bands that support sidelink communication and combinations of frequency bands that can be used in combination for sidelink communication. This information includes only information on frequency bands for sidelink and does not include information unrelated to sidelink communication, such as information on radio repeaters. For this reason, in the present embodiment, this information can be extended to make it possible to inquire about information on a frequency band that is usable for the radio repeater portion. Note that the terminal apparatus 101 may transmit a ue-CapabilityInformationSidelink message including capability information of the terminal apparatus 101 to the relay devices 121 and 122, similarly to the conventional UECapabilityEnquirySidelink message. Note that this is an example, and the capability information does not need to be transmitted from the terminal apparatus 101 to the relay devices 121 and 122. In addition, the message that is an extension of the UECapabilityEnquirySidelink message may include information inquiring about the number and configuration of antennas of the radio repeater portions of the relay devices 121 and 122.

The relay devices 121 and 122 notify the terminal apparatus 101 of, for example, information indicating whether they have a function as a radio repeater, using a message that is an extension of the UECapabilityinformationSidelink message. In addition, the relay devices 121 and 122 can notify the terminal apparatus 101 of supported frequency bands (and combinations of supported frequency bands) of the radio repeater portions using information similar to the conventional supportedBandCombinationListSidelink and supportedBandListSidelink. In addition, the relay devices 121 and 122 perform notification of the number and configuration of antennas in the radio repeater portions.

Note that the above-mentioned capability information may be notified from the relay devices 121 and 122 to the terminal apparatus 101 without following the sidelink communication regulations. For example, the capability information may be notified using a Bluetooth (registered trademark) profile. That is, the terminal apparatus 101 and the communication function units 131 of the relay devices 121 and 122 can be configured to perform Bluetooth communication. Then, in the above-mentioned step S202, the relay devices 121 and 122 can notify the terminal apparatus 101 of information such as whether or not they have the function as a virtual antenna, the supported frequency bands, and the number and configuration of antennas, using Generic Attribute Profile (GATT). Note that the terminal apparatus 101 may also notify the relay devices 121 and 122 of its own information using GATT. In addition, the terminal apparatus 101 and the communication function units 131 of the relay devices 121 and 122 may transmit and receive capability information using a wireless LAN.

The terminal apparatus 101 specifies, for example, the relay devices 121 and 122 that can operate as virtual antennas from the acquired capability information of the relay devices 121 and 122. Then, the terminal apparatus 101 recognizes the configuration of the virtual antennas based on the frequency bands and the number and configuration of antennas that are usable by the relay devices 121 and 122 on the base station apparatus 151 side, and can communicate with the base station apparatus 151 using that configuration. Note that the relay devices 121 and 122 may transmit their own capability information without receiving an inquiry message from the terminal apparatus 101. For example, the relay devices 121 and 122 may proactively send out their own capability information in response to, for example, being powered on, accepting a user operation to turn on the function as a virtual antenna, or the like. By detecting such capability information, the terminal apparatus 101 can recognize that there is a device that has the function as a virtual antenna in the surrounding area.

### Update of Capability Information of Terminal Apparatus

In this manner, the terminal apparatus 101 can communicate with the base station apparatus 151 with use of the relay devices 121 and 122 as virtual antennas. The terminal apparatus 101 will notify the base station apparatus 151 of capability information such as the number of antennas, under the premise that such virtual antennas are present. For example, if the relay devices 121 and 122 each have two antennas on the base station apparatus 151 side, the terminal apparatus 101 can be said to virtually have four antennas since the two relay devices each have two antennas. For this reason, in such a case, the terminal apparatus 101 can notify the base station apparatus 151 that it has four antennas as the capability information. On the other hand, in such an environment, the number of virtual antennas in the terminal apparatus 101 can change, for example, if one of the relay devices 121 and 122 is powered off, if a connection with a new relay device is established, or the like.

In addition, for example, when transmitting channel state information (CSI) to the base station apparatus 151, the terminal apparatus 101 can compress the CSI using artificial intelligence (AI)/machine learning (ML). For example, a first trained model for acquiring compressed CSI that can achieve a compression rate determined by a predetermined criterion, such as the lowest compression rate or a compression rate below a reference value, through ML using uncompressed CSI as input, and a second trained model for acquiring uncompressed CSI through ML using the compressed CSI as input are acquired. At this time, the terminal apparatus 101 holds the first trained model, and the base station apparatus 151 holds the second trained model. For example, the terminal apparatus 101 can acquire CSI through channel estimation in the terminal apparatus 101 itself, perform ML based on that information to generate a first trained model and a second trained model, and notify the base station apparatus 151 of the second trained model. This second trained model is provided from the terminal apparatus 101 to the base station apparatus 151 as, for example, capability information. Note that the capability information may also indicate only whether or not CSI compression and decompression is possible using the first trained model and the second trained model, and the second trained model may be notified to the base station apparatus 151 separately from the capability information. As a result, upon acquiring CSI through channel estimation, the terminal apparatus 101 compresses the CSI using the first trained model and transmits the result to the base station apparatus 151, and the base station apparatus 151 can input the received compressed CSI into the second trained model to obtain the result of channel estimation in the terminal apparatus 101. By contrast, if the communication environment between the terminal apparatus 101 and the base station apparatus 151 changes significantly, for example, it is envisioned that the trained model will no longer be suitable for that communication environment. In this case, the terminal apparatus 101 can update the second trained model that was notified to the base station apparatus 151 as capability information.

In addition, the terminal apparatus 101 can control a beam to be used in communication between the terminal apparatus 101 and the base station apparatus 151 using AI/ML. For example, the terminal apparatus 101 and the base station apparatus 151 measure radio quality using only a portion of many available beams, and then use the measurement results as input to perform ML to select the optimal beam from all available beams, thereby generating a trained model. In one example, the base station apparatus 151 transmits measurement signals using all available beams, and the terminal apparatus 101 selects the optimal beam from the measurement results of the signals, while at the same time, a trained model can be generated using ML, which uses the measurement results of signals transmitted using some of the beams as input and the selected optimal beam as training data. At this time, the terminal apparatus 101 can notify the base station apparatus 151, as capability information, that it is capable of performing beam selection using the trained model. In this case as well, if the communication environment between the terminal apparatus 101 and the base station apparatus 151 changes significantly, it is envisioned that the trained model will no longer be suitable for that communication environment. In this case, it is envisioned that the terminal apparatus 101 will be unable to perform beam selection using a trained model, even though it has notified the base station apparatus 151 that it is capable of doing so as capability information.

In this way, it is envisioned that the capability information of the terminal apparatus 101 will dynamically change if a virtual antenna is used or if AI/ML is used. In contrast to this, conventionally, the terminal apparatus 101 cannot provide its own capability information to the base station apparatus 151 unless there is an inquiry from the base station apparatus 151. For this reason, the base station apparatus 151 can end up communicating with the terminal apparatus 101 according to inaccurate capability information. Here, when the base station apparatus 151 establishes connection with the terminal apparatus 101, the base station apparatus 151 acquires capability information of the terminal apparatus 101. For this reason, the terminal apparatus 101 can also terminate connection and execute reconnection processing every time the capability information fluctuates. However, in this case, disconnection and reconnection will be repeated every time the configuration of the virtual antennas or the communication conditions in the terminal apparatus 101 change, which can significantly increase signaling overhead.

In the present embodiment, in consideration of such circumstances, the terminal apparatus 101 is allowed to proactively transmit capability information to the base station apparatus 151 while maintaining connection with the base station apparatus 151. FIGS. 3A and 3B show an example of the flow of this processing. For example, if the terminal apparatus 101 detects a need to change the capability information (step S301), the terminal apparatus 101 decides to transmit the capability information to the base station apparatus 151 (step S302). Then, the terminal apparatus 101, for example, proactively transmits capability information to the base station apparatus 151. The terminal apparatus 101 transmits UECapabilityInformation to the base station apparatus 151 without receiving an inquiry message from the base station apparatus 151. In addition, the terminal apparatus 101 may request, for example, the base station apparatus 151 to transmit an inquiry message (step S311). That is, the terminal apparatus 101 transmits, to the base station apparatus 151, a message requesting transmission of a UECapabilityEnquiry message. Upon receiving a UECapabilityEnquiry transmitted in response to this request message from the base station apparatus 151 (step S312), the terminal apparatus 101 transmits UECapabilityInformation to the base station apparatus 151 in response thereto (step S313). In this way, the terminal apparatus 101 transmits a signal for transmitting capability information to the base station apparatus 151 in a state where no inquiry about capability information has been received from the base station apparatus 151. Then, the terminal apparatus 101 uses this signal to notify the base station apparatus 151 of the changed capability information, whereby the base station apparatus 151 can control the communication of the terminal apparatus 101 using accurate capability information.

The message that the terminal apparatus 101 uses to transmit capability information or an inquiry message for capability information to the base station apparatus 151 is transmitted using, for example, a radio resource control (RRC) message, a physical uplink control channel (PUCCH), or a medium access control (MAC) control element (CE). Note that when the terminal apparatus 101 proactively transmits capability information, in the capability information, all of the changed capability information of the terminal apparatus 101 may be transmitted to the base station apparatus 151, or only the changed part of the capability information may be transmitted to the base station apparatus 151. In addition, in a message for causing the base station apparatus 151 to transmit an inquiry message for capability information, the terminal apparatus 101 may transmit only a request to transmit the inquiry message, or may transmit, for example, information indicating which item of the capability information is to be changed.

Note that the capability information transmitted from the terminal apparatus 101 to the base station apparatus 151 can include, for example, information related to MIMO (Multiple Input Multiple Output) and information on the corresponding frequency bands. The information relating to MIMO includes, for example, sounding reference signal (SRS) setting information (SRSConfig), beam setting information (SpatialrelationInfo), and the number of MIMO layers for each of the downlink and uplink (maxNumberMIMOLayersPDSCH, maxNumberMIMO-LayersCBPUSCH). In addition, as described above, the capability information can include information needed to execute the function, such as information on AI/ML models.

The terminal apparatus 101 can determine that the capability information needs to be changed, for example, in response to a loss of connection with a relay device used as a virtual antenna, or if a new connection is made with a relay device used as a virtual antenna. In addition, the terminal apparatus 101 can, for example, input the CSI into a first trained model for compression, and then input the obtained compressed CSI into a second trained model for decompression, and determine whether the original CSI has been restored, and if the original CSI is not accurately restored (if the error exceeds a predetermined value), the terminal apparatus 101 can determine that the capability information needs to be changed (the model needs to be re-trained). In addition, the terminal apparatus 101 can input a measurement result of only a portion of the available beams into a trained model and determine whether or not the beam specified as the beam to be used is the optimal beam among all the available beams. That is, the terminal apparatus 101, for example, periodically executes measurement on all available beams and determines whether the beam to be used, which is determined based on the result of the measurement, matches the beam specified using the trained model. If the beams do not match, the terminal apparatus 101 can determine that the capability information needs to be changed (the model needs to be re-trained). In one example, if the model needs to be re-trained, the terminal apparatus 101 can transmit, to the base station apparatus 151, a request to transmit capability information or an inquiry message for capability information in response to completion of the re-learning. As a result, a re-trained model is present at the time when the message is transmitted, making it possible to perform communication using the re-trained model in a short amount of time.

In addition, the terminal apparatus 101 may transmit, to the base station apparatus 151, a request to transmit capability information or a capability information inquiry message in response to determining that the model needs to be re-trained. In this case, the base station apparatus 151 can immediately stop using the trained model for decompressing CSI that is no longer suitable for the communication conditions, for example. Note that until the terminal apparatus 101 updates the trained model and provides the updated trained model to the base station apparatus 151, and until the base station apparatus 151 receives the updated trained model, CSI can be provided from the terminal apparatus 101 to the base station apparatus 151 using a conventional procedure. As a result, it is possible to prevent communication control based on inaccurate CSI caused by using an unsuitable trained model. In addition, the base station apparatus 151 can transmit measurement signals on all available beams to cause the terminal apparatus 101 to execute re-training, for example, in order to update the trained model for beam control that is no longer suitable for the communication conditions.

### Reporting Radio Quality to Terminal Apparatus by Relay Device

When communication is performed between the terminal apparatus 101 and the base station apparatus 151 with use of the relay devices 121 and 122 as described above, both the radio quality regarding the first transmission path (e.g., in the THz band) between the terminal apparatus 101 and the relay devices 121 and 122 and the radio quality regarding the second transmission path (e.g., in the millimeter-wave band) between the relay devices 121 and 122 and the base station apparatus 151 influence the communication quality of the communication between the terminal apparatus 101 and the base station apparatus 151. For example, it is envisioned that a radio signal transmitted from the base station apparatus 151 is received at low power by the relay devices 121 and 122, and noise caused by the relay devices 121 and 122 is added to the radio signal, resulting in a low signal-to-noise ratio (SNR). When the radio signal with the low SNR is amplified, not only the signal component but also the noise component is significantly amplified, and therefore even if the reception power of the radio signal at the terminal apparatus 101 is sufficient, the SNR of the radio signal remains low. Similarly, if the SNR of the radio signal transmitted from the terminal apparatus 101 and received at the relay devices 121 and 122 is low, the SNR of the radio signal will remain low even if the reception power of the radio signal transmitted from the relay devices 121 and 122 and received at the base station apparatus 151 is sufficient. That is, because the power of the signal reaching the relay devices 121 and 122 is low, the SNR becomes low due to noise caused by the relay devices 121 and 122, and when the radio signal is amplified, the SNR of the radio signal can remain low even if the reception power of the radio signal at the terminal apparatus 101 and the base station apparatus 151 is sufficient.

In such a case, it can be envisioned that in communication between the terminal apparatus 101 and the base station apparatus 151, radio signals cannot be transmitted and received normally even though the radio quality (reception power) at the terminal apparatus 101 appears to be favorable. In response to this, the terminal apparatus 101 can ensure sufficiently high communication quality of the communication between the terminal apparatus 101 and the base station apparatus 151 by using, for example, as a virtual antenna, a relay device that can achieve a predetermined quality level in the radio quality in both the first transmission path and the second transmission path described above. On the other hand, the terminal apparatus 101 and the base station apparatus 151 can recognize the communication quality of the communication over the entire transmission path between the terminal apparatus 101 and the base station apparatus 151, for example, using an existing technique such as channel estimation, but cannot recognize communication quality that distinguishes between the first transmission path and the second transmission path. For this reason, the terminal apparatus 101 cannot select a suitable relay device for ensuring a sufficiently high communication quality of the communication between the terminal apparatus 101 and the base station apparatus 151.

In this embodiment, in consideration of such circumstances, the relay devices 121 and 122 specify the above-described radio quality of the first transmission path and the radio quality of the second transmission path in the relay function units 132, and notify the terminal apparatus 101 of the result of specifying. For example, the relay function units 132 of the relay devices 121 and 122 measure predetermined signals transmitted from the terminal apparatus 101 and the base station apparatus 151 to measure the radio quality of the first transmission path and the radio quality of the second transmission path, respectively. The relay function units 132 then provide the measurement results to the communication function units 131, and the communication function units 131 notify the terminal apparatus 101 of the provided measurement values of the radio quality. Here, the predetermined signal can be, for example, a reference signal or a synchronization signal generated using a known sequence, and the radio quality can be, for example, the reception power of the signal or the signal-to-noise-and-interference ratio (SINR). The relay function unit 132 can measure the radio quality through, for example, correlation detection using a known sequence used to generate the predetermined signal. In addition, for example, the relay function unit 132 may measure the reception power of the radio signal using a power detector connected to the antennas on the terminal apparatus 101 side and the base station apparatus 151 side, or the like. In addition, the power detector may be arranged so as to be accessible by the communication function unit 131, in which case the relay function unit 132 does not need to have a correlation detection function, a function for providing information to the communication function unit 131, or the like. That is, the relay function unit 132 may include only functions as a radio repeater, such as amplification of a received signal and frequency conversion. Note that only the radio quality of at least one of the first transmission path and the second transmission path can be measured and reported to the terminal apparatus 101. That is, only the radio quality of the first transmission path may be measured and reported, only the radio quality of the second transmission path may be measured and reported, or both may be measured and reported.

Note that the relay devices 121 and 122 may, for example, periodically measure the radio quality of the first transmission path and the radio quality of the second transmission path, respectively, or may perform the measurement in response to receiving an instruction from the terminal apparatus 101. In one example, the base station apparatus 151 can transmit a predetermined notification to the terminal apparatus 101 if the reception power of a signal from the terminal apparatus 101 is sufficient but the quality, such as the SNR, is insufficient. Then, when the terminal apparatus 101 receives the predetermined notification, the terminal apparatus 101 can transmit an instruction signal to the relay devices 121 and 122 to execute measurement. Similarly, the terminal apparatus 101 can transmit an instruction signal to the relay devices 121 and 122 to perform measurement if the reception power of a signal from the base station apparatus 151 is sufficient but the quality, such as the SNR, is insufficient.

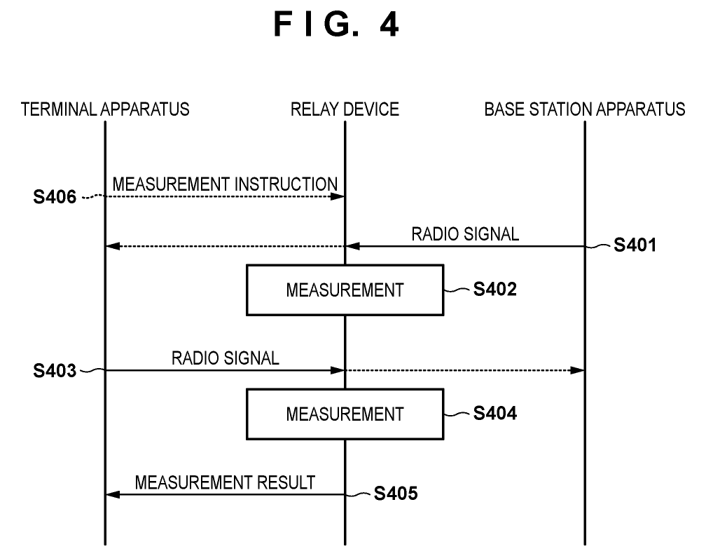

FIG. 4 shows an example of a flow of this processing. In this processing, the relay devices 121 and 122 measure the radio quality, such as the reception power of the downlink radio signal transmitted from the base station apparatus 151 (step S401, step S402), and measure the radio quality, such as the reception power of the uplink radio signal transmitted from the terminal apparatus 101 (step S403, step S404). Note that the relay devices 121 and 122 are connected to the terminal apparatus 101 and function as virtual antennas, with signals transmitted from the base station apparatus 151 being relayed to the terminal apparatus 101 and signals transmitted from the terminal apparatus 101 being relayed to the base station apparatus 151. The relay devices 121 and 122 notify the terminal apparatus 101 of at least one of the measurement results in step S402 and step S404 (step S405). Note that the notification in step S405 can be performed using, for example, sidelink communication, Bluetooth, wireless LAN, or the like. In addition, when sidelink communication is used, the notification of step S405 can be performed using a physical sidelink control channel (PSCCH) or a physical sidelink shared channel (PSSCH). In addition, the relay devices 121 and 122 may perform measurement and reporting periodically, or may perform measurement and reporting aperiodically in accordance with a measurement instruction from the terminal apparatus 101 (step S406). In addition, the terminal apparatus 101 may instruct the communication function units 131 of the relay devices 121 and 122 to perform reporting on the condition that the measurement results satisfy a predetermined condition, for example. In this way, the terminal apparatus 101 can acquire the measurement results of the radio quality for the first transmission path between the terminal apparatus 101 and the relay devices 121 and 122, and the measurement results of the radio quality for the second transmission path between the terminal apparatus 101 and the base station apparatus 151.

Upon receiving the measurement results of the radio quality at the relay devices 121 and 122, the terminal apparatus 101 transmits the measurement results to the base station apparatus 151, for example. The base station apparatus 151 can execute transmission power control and the like based on the measurement results. For example, if the radio quality (e.g., the reception power at the relay devices 121 and 122) of the second transmission path is low, the base station apparatus 151 performs control to increase the transmission power of the downlink signal. In addition, if the received measurement result of the radio quality indicates that the radio quality for the first transmission path is lower (e.g., lower than a predetermined value), the terminal apparatus 101 can perform control to increase the transmission power of the uplink signal. In addition, if the terminal apparatus 101 is using, as a virtual antenna, a relay device whose radio quality for at least one of the first transmission path and the second transmission path is insufficient (the radio quality is below a predetermined value), the terminal apparatus 101 can stop using the relay device. In addition, the terminal apparatus 101 may switch the relay device to be used. Note that the terminal apparatus 101 may instruct relay devices that are not being used as virtual antennas to measure and report radio quality. As a result, the terminal apparatus 101 can select a relay device with favorable radio quality from among unused relay devices and use the selected relay device as a new virtual antenna.

### Frequency Conversion in Relay Devices

As described above, the terminal apparatus 101 multiplexes and transmits signals to the relay devices 121 and 122 using polarization and a plurality of frequency channels (e.g., in the THz band), and the relay devices 121 and 122 convert the signals into signals of one frequency channel and relay them to the base station apparatus 151. At this time, if the converted frequency channels in the relay devices 121 and 122 are provided in a fixed manner, many terminal apparatuses using virtual antennas will use those frequency channels, making it difficult to secure sufficient resources for those frequency channels. Note that a plurality of “frequency channels” mentioned here may be set for one frequency band, or only one may be set for one frequency band. That is, a frequency channel may be a partial band within one frequency band, or may be the entirety of one frequency band.

For this reason, in this embodiment, the relay devices 121 and 122 are configured to be able to use a plurality of different frequency channels included in a frequency band that can be used to relay a radio signal to the base station apparatus 151. Then, the relay devices 121 and 122 set the frequency channel to be used when relaying the signal to the base station apparatus 151 in accordance with the instruction from the terminal apparatus 101. As a result, it is possible to prevent communication of a large number of terminal apparatuses using relay devices from concentrating in a specific frequency channel, and it is possible to improve the flexibility of frequency resource allocation.

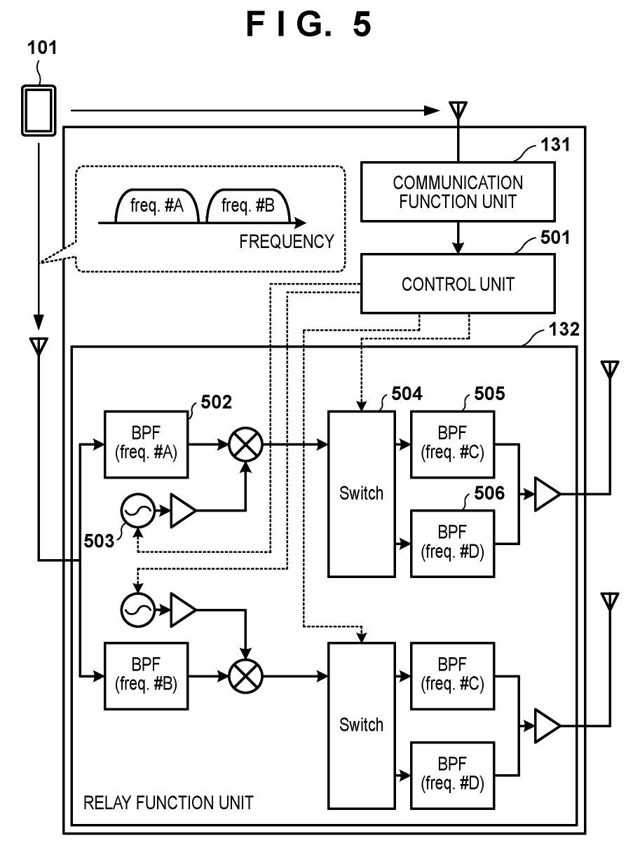

FIG. 5 shows an example of the configuration of the relay devices 121 and 122 according to the present embodiment. For example, the terminal apparatus 101 transmits radio signals containing different data on a frequency channel A and a frequency channel B. Upon receiving the radio signals, the relay devices 121 and 122 separate the radio signals using a bandpass filter (BPF) 502 that allows only a band of the frequency channel A to pass and a BPF that allows only a band of the frequency channel B to pass. The relay devices 121 and 122 then perform frequency conversion on the frequencies of these radio signals to a frequency C or a frequency D using the waveform output by an oscillator 503, for example. The frequency-converted radio signals are supplied to a switch 504 so as to be input to either a BPF 505 for the frequency C or a BPF 506 for the frequency D. For example, if a radio signal is to be output at the frequency C, the switch 504 switches the output destination such that the radio signal is input to the BPF 505 and is not input to the BPF 506. In addition, for example, if a radio signal is to be output at the frequency D, the switch 504 switches the output destination such that the radio signal is input to the BPF 506 and is not input to the BPF 505. If the frequency of the radio signal to be relayed is the frequency C, the radio signal that has passed through the BPF 505 is amplified and relayed (output from the antenna), and if the frequency of the radio signal to be relayed is the frequency D, the radio signal that has passed through the BPF 506 is amplified and relayed (output from the antenna).

Note that although FIG. 5 shows an example in which two frequency bands (frequency C and frequency D) can be used to relay radio signals to the base station apparatus 151, the relay devices 121 and 122 may also be configured to be able to use three or more frequency bands. In addition, although an example is shown in which the radio signals transmitted from the terminal apparatus 101 to the relay devices 121 and 122 are frequency-multiplexed, they may also be multiplexed using polarization or time, for example. In this case, the relay devices 121 and 122 may perform radio signal conversion processing to separate signals transmitted at different polarizations and times such that the signals are transmitted at the same frequency and time using a plurality of antennas. In either case, however, when the relay function unit 132 operates as a radio repeater, it is not necessary to perform processing such as demodulation and decoding of signals, and re-encoding and re-modulation.

Note that the relay devices 121 and 122 receive instruction information from the terminal apparatus 101 using the communication function units 131, for example. The instruction information includes the changed frequency. Upon receiving instruction information from the terminal apparatus 101, the communication function unit 131 supplies the instruction content to a control unit 501. Then, in the relay devices 121 and 122, the control unit 501 controls the frequency of the oscillator 503 and the switch 504 such that a radio signal of a designated frequency is output. That is, the control unit 501 controls the oscillation frequency of the oscillator 503, and further sets the output destination of the switch 504 such that the radio signal after frequency change is input to a suitable BPF. Note that, as described above, the relay devices 121 and 122 notify the terminal apparatus 101 of available frequency bands (frequency channels) as capability information. The terminal apparatus 101 transmits information about the frequency bands indicated as usable by the capability information to the base station apparatus 151 as the capability information of the terminal apparatus 101. The base station apparatus 151 then selects one of the usable frequency bands indicated as the capability information, and allocates frequency resources included in the selected frequency band to the terminal apparatus 101. The terminal apparatus 101 instructs the relay devices 121 and 122 to use the allocated frequency band. The control units 501 of the relay devices 121 and 122 then convert the radio signal received from the terminal apparatus 101 into a radio signal in that frequency band and relay the resulting radio signal.

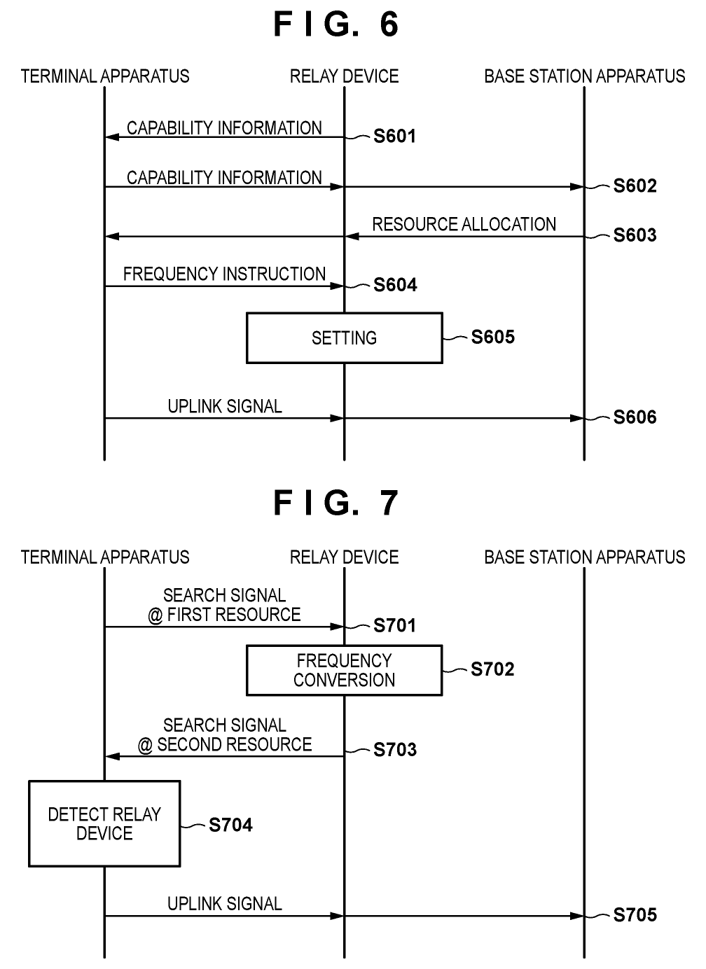

FIG. 6 shows an example of a flow of frequency setting processing in the relay devices 121 and 122. In this processing, first, the relay devices 121 and 122 transmit capability information including frequency bands that can be used to relay radio signals to the base station apparatus 151, to the terminal apparatus 101 (step S601). Then, the terminal apparatus 101 notifies the base station apparatus 151 (e.g., via the relay devices 121 and 122, or directly without going through the relay devices 121 and 122) of capability information indicating the frequency bands that the relay devices 121 and 122 can use as the frequency bands that the terminal apparatus 101 can use (step S602). Then, the base station apparatus 151 selects one of the frequency bands indicated by the capability information, allocates resources for uplink communication in that frequency band, and notifies the terminal apparatus 101 of information indicating the allocated resources (e.g., via the relay devices 121 and 122, or directly without going through the relay devices 121 and 122) (step S603). Note that the base station apparatus 151 can notify the terminal apparatus 101 of a combination of information about the frequency band to be used and information indicating which resources in that frequency band are to be allocated. Note that if the frequency band including the frequency resource is specified by the information specifying the frequency resource, the information about the frequency band does not need to be notified to the terminal apparatus 101. The terminal apparatus 101 transmits an instruction to the relay devices 121 and 122 to relay uplink signals to the base station apparatus 151 using a frequency band corresponding to the allocated frequency resource (step S604). Then, in accordance with the instruction, the relay devices 121 and 122 control, for example, the oscillator 503 and the switch 504 to perform settings to relay the uplink signal to the base station apparatus 151 using the instructed frequency band (step S605).

Note that the base station apparatus 151 may notify the terminal apparatus 101 of information indicating which frequency band is to be used in which time slot (time). In this case, the terminal apparatus 101 similarly notifies the relay devices 121 and 122 of information associating time slots with frequency bands to be used, and the control units 501 of the relay devices 121 and 122 can execute control processing to change the frequency bands to be used over time in accordance with the information. This makes it possible to switch the used frequency band at a suitable timing, allowing for more flexible use of many frequency bands. In addition, information associating a plurality of time slots (times) with the corresponding frequency bands to be used may be notified to the relay devices 121 and 122. The relay devices 121 and 122 perform control such that the corresponding frequency bands are used in each of the plurality of time slots. In this way, by performing notification of information designating the change over time in the frequency band to be used, the number of instances of transmitting the instruction signal can be reduced, and the frequency band to be used can be switched frequently and flexibly. Note that the terminal apparatus 101 may transmit instructions on the used frequency bands to the plurality of relay devices 121 and 122 individually, or may transmit the instructions to all of them at once by multicasting.

Thereafter, the terminal apparatus 101 transmits an uplink signal using a time and frequency range in the frequency band before conversion by the relay devices 121 and 122 that corresponds to the resources allocated in step S603 (e.g., a specific time and frequency range in the frequency band to be used, which is indicated by a resource block). For example, if the lower end of the frequency band (e.g., frequency C or frequency D in FIG. 5) used when relaying radio signals from the relay devices 121 and 122 to the base station apparatus 151 is f2, the lower end of the allocated frequency resource is f2+Δ, and the lower end of the frequency band (e.g., frequency A in FIG. 5) used when transmitting radio signals from the terminal apparatus 101 to the relay devices 121 and 122 is f0, then the terminal apparatus 101 transmits an uplink signal in a frequency resource whose lower end is f0+Δ. Note that as shown in FIG. 5, when transmitting radio signals to the relay devices 121 and 122 using a plurality of frequency bands, if the lower ends of two frequency bands (e.g., frequency A and frequency C in FIG. 5) are f0 and f1 respectively, for example, the terminal apparatus 101 transmits uplink signals in frequency resources whose lower ends are f0+Δ and f1+Δ. In this way, for example, the base station apparatus 151 can flexibly allocate radio resources, and it becomes possible to prevent congestion in only a specific frequency band.

### Identification of Relay Devices with Only Analog Functions

In the example above, an example was described in which the terminal apparatus 101 uses a sidelink communication function or the like to discover and connect to the relay devices 121 and 122 having the communication function units 131, and uses the connected relay devices 121 and 122 as virtual antennas. The terminal apparatus 101 determines its own (virtual) capabilities, such as the number of MIMO layers, by recognizing relay devices that can be used as virtual antennas, and therefore when using virtual antennas, it is necessary to recognize the relay devices. On the other hand, if the relay devices 121 and 122 only have the relay function units 132 and do not have the communication function units 131, it is envisioned that the terminal apparatus 101 will not be able to discover the relay devices 121 and 122 because it will not be able to use the sidelink communication function or the like.

In this embodiment, in consideration of the above circumstances, in order to discover a relay device having only the relay function unit 132, the terminal apparatus 101 sends out at least one of a signal in a first frequency band (e.g., THz band) used when communicating with the base station apparatus 151 using a virtual antenna and a signal in a second frequency band (e.g., millimeter-wave band) after conversion by the relay device, and in response thereto, detects radio waves in the frequency band after frequency conversion (which is performed when a relay device is present). That is, if there is a relay device nearby, a radio signal sent out by the terminal apparatus 101 is subjected to frequency conversion by the relay device and output, and if the terminal apparatus 101 can detect the radio signal resulting from frequency conversion, it can determine that a relay device is nearby. That is, if the terminal apparatus 101 detects a signal in the second frequency band after transmitting a signal in the first frequency band, or if it detects a signal in the first frequency band after transmitting a signal in the second frequency band, the terminal apparatus 101 can determine that a relay device is nearby.

Note that the terminal apparatus 101 can periodically transmit at least one of a signal in the first frequency band and a signal in the second frequency band, and perform detection processing of the signal in the converted frequency band. However, there is no limitation to this, and the terminal apparatus 101 may also transmit a signal and perform detection processing when a predetermined event is detected. For example, when a user operation on the terminal apparatus 101 instructs the start of detection, the terminal apparatus 101 can transmit a signal and execute detection processing. For example, the relay device is a device whose presence can be recognized by the user, such as a wireless device held by the user, such as a smart watch, and it is envisioned that the user turns on a switch of the device to instruct the start of detection of the device.

Here, it is assumed that the relay device has a constant amplification factor, for example. At this time, the terminal apparatus 101 transmits a signal with sufficiently weak power. This prevents, for example, a signal transmitted by the terminal apparatus 101 in a first frequency band from interfering strongly with signals from other terminal apparatuses in the base station apparatus 151, even if the signal transmitted by the terminal apparatus 101 is amplified by a relay device and output in a second frequency band. Similarly, the terminal apparatus 101 transmits a signal in the second frequency band with sufficiently weak power and detects a signal in the first frequency band. Note that signals in the THz band are significantly attenuated over distance, and even if they are amplified and output, the range of their radio waves is limited, and thus it is envisioned that they will not interfere with other signals.

Note that, for example, frequency and time resources for searching for relay devices may be prepared in the form of a resource pool. For example, a resource that allows the terminal apparatus 101 to transmit a search signal and a corresponding resource that allows the terminal apparatus 101 to receive a signal that has been subjected to frequency conversion and relayed are set. For example, a frequency and time resource in the THz band is prepared as a first resource, and a frequency and time resource in the millimeter-wave band corresponding to the first resource is prepared as a second resource. In addition, a frequency and time resource in the millimeter-wave band is prepared as a third resource, and a frequency and time resource in the THz band corresponding to the third resource is prepared as a fourth resource. The terminal apparatus 101 determines whether or not a relay device is present by transmitting a signal in the first resource or the third resource and determining whether or not the frequency-converted signal is detected in the second resource or the fourth resource. For example, the first resource can be set to a period of time in which the base station apparatus 151 does not transmit a millimeter-wave band signal. For example, the first resource is set in a time slot to which uplink resources are allocated. Note that the second resource corresponding to the first resource can also be set in the same time slot. If a relay device is present, the signal transmitted using the first resource in the THz band is converted by the relay device into a signal using the second resource in the millimeter-wave band and relayed. According to the above-described setting, signals in the millimeter-wave band are not transmitted from the base station apparatus 151, and therefore the terminal apparatus 101 can measure signals in the millimeter-wave band relayed by the relay device under a condition where there is no interference. The above-described third resource can also be set at a timing when the base station apparatus 151 does not transmit a millimeter-wave signal, that is, in a time slot allocated to the uplink. The terminal apparatus 101 transmits a millimeter-wave signal in the third resource in which the base station apparatus 151 does not transmit a millimeter-wave signal, and executes detection processing for a signal in the THz band in the fourth resource. According to the above-described setting, the base station apparatus 151 does not transmit a signal in the millimeter-wave band, and therefore the relay device does not relay the signal in the millimeter-wave band, and therefore the terminal apparatus 101 can measure the signal in the millimeter-wave band relayed by the relay device under a condition where there is no interference. Note that it is envisioned that a signal in the THz band is transmitted between another terminal apparatus and corresponding relay devices, but due to the high frequency of these signals, interference with signals transmitted between the terminal apparatus 101 and the relay devices can be ignored.

In this way, the terminal apparatus 101 can recognize a relay device that does not have the communication function unit 131 and use the relay device as a virtual antenna. Note that in the above-described example, an example was described in which the terminal apparatus 101 transmits a signal for searching for a relay device in a period of time in which the base station apparatus 151 does not transmit a millimeter-wave signal, but there is no limitation to this. For example, the terminal apparatus 101 may notify the base station apparatus 151 that a search for relay devices will be performed, and receive, from the base station apparatus 151, allocation of resources for the search. In this case, the terminal apparatus 101 can transmit a search signal while the base station apparatus 151 is transmitting a signal in the millimeter-wave band. However, in correspondence with the radio resource by which the terminal apparatus 101 transmits a signal in the millimeter-wave band for search or the THz-band radio resource by which the terminal apparatus 101 transmits a search signal, the base station apparatus 151 is configured not to transmit a signal in the radio resource in the millimeter-wave band that the relay device uses to relay the signal. This makes it possible to prevent interference caused by a signal from the base station apparatus 151 from occurring in the radio resources used by the terminal apparatus 101 to search for relay devices. It is also envisioned that, for example, the relay device can relay radio signals in a plurality of frequency bands, as described above. For this reason, the terminal apparatus 101 may execute signal detection processing in the plurality of frequency bands. That is, the terminal apparatus 101 may execute processing for detecting relay devices using a combination of a plurality of frequency bands. Note that since the terminal apparatus 101 knows the signal that it has transmitted, it may detect the signal from the relay device by performing correlation detection using the waveform obtained by performing frequency conversion on the signal, or it may detect the signal from the relay device by simply executing power detection in the resource after frequency conversion.

In addition, if there are a plurality of relay devices, the terminal apparatus 101 can execute detection processing to detect each of the plurality of relay devices. For example, the terminal apparatus 101 can form a plurality of beams and execute detection processing for each beam to detect relay devices present in the direction in which the beam is pointed, and can detect relay devices present in other directions using other beams. That is, the terminal apparatus 101 performs detection processing for each beam, whereby it can detect relay devices that are present in different directions by separating them by beam. Note that by changing the beam to be used over time, it is possible to identify which beam the relay device was discovered on, but there is no limitation to this. For example, the terminal apparatus 101 may perform relay device detection processing by using a plurality of beams in parallel, with different sequences being used for respective beams. That is, the terminal apparatus 101 can specify the beam direction in which the relay device is present based on the sequence signal that is detected. In addition, for example, if all relay devices to be searched for perform the same frequency conversion, the terminal apparatus 101 may perform relay device detection processing by using a plurality of beams in parallel, with different frequency resources used for each beam. That is, the terminal apparatus 101 can specify the beam direction in which the relay device is present based on the frequency resource on which the signal is detected.

FIG. 7 shows an example of a flow of processing in which the terminal apparatus 101 searches for a relay device that does not have a communication function unit 131. The terminal apparatus 101 transmits a search signal in the first resource (or the third resource) periodically or in response to the occurrence of a predetermined event (step S701). For example, after a relay device is powered on by a user operation, the relay device converts the frequency of the signal to the second resource (or the fourth resource if the relay device receives a search signal transmitted using the third resource) (step S702), amplifies the signal, and then outputs the amplified signal (step S703). Upon receiving the radio signal transmitted from the relay device in the second resource, the terminal apparatus 101 detects the relay device (step S704). For example, the terminal apparatus 101 can determine whether or not the received signal is a signal that has been relayed by a relay device by determining whether or not the received signal is a signal obtained by performing frequency conversion on a radio signal transmitted by the terminal apparatus 101, and can determine whether or not a relay device is present based on the determination result. However, there is no limitation to this, and it may be determined that a relay device is present when, for example, power greater than or equal to a predetermined level is detected in the second resource. Then, in response to determining that a relay device is present, the terminal apparatus 101 communicates with the base station apparatus 151 using the relay device as a virtual antenna.

In this way, when there is a relay device that does not have a communication function unit 131, the terminal apparatus 101 can detect the relay device and use the relay device as a virtual antenna to communicate with the base station apparatus 151.

### Device Configuration

Next, an example of the configuration of the terminal apparatus 101 and the relay devices 121 and 122 configured to execute the above-mentioned processing will be described. Note that the functions that the terminal apparatus 101 and the relay devices 121 and 122 are to include are as described above, and therefore the following description will be limited to a rough outline of the configuration of the terminal apparatus 101 and the relay devices 121 and 122. Note that the base station apparatus 151 has roughly the same function as a conventional base station apparatus, and therefore will not be described here. Note that the detailed operation of the base station apparatus 151 is as described above.

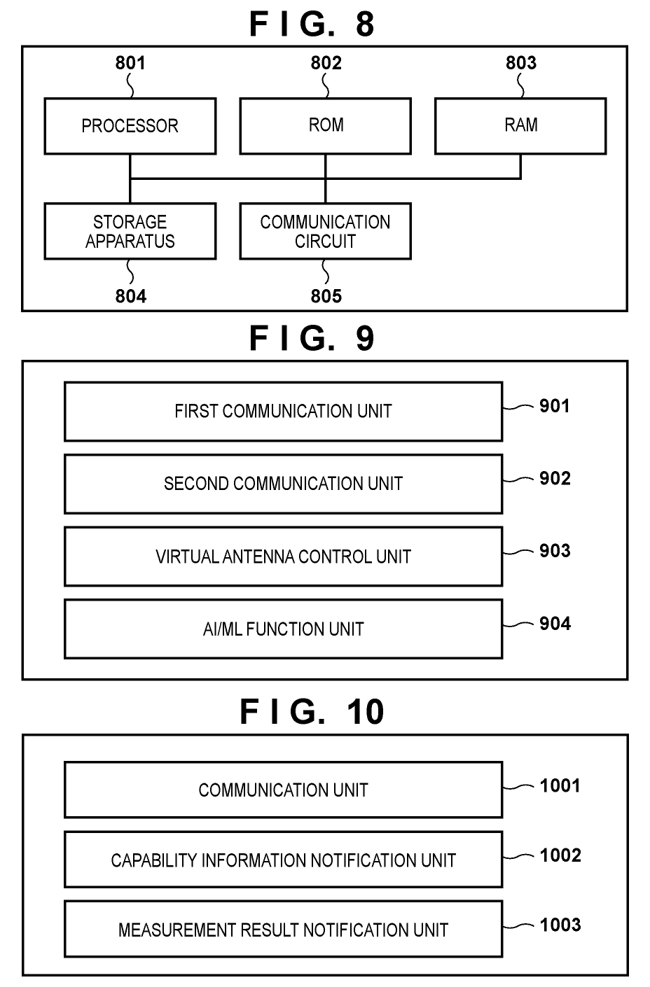

FIG. 8 shows an example of the hardware configuration of the terminal apparatus 101, and the communication function units 131 and the control units 501 of the relay devices 121 and 122 according to this embodiment. Note that in the following description, the communication function unit 131 and the control unit 501 of the relay device are referred to simply as relay devices in some cases. In one example, the terminal apparatus 101 and the relay devices 121 and 122 each include a processor 801, a ROM 802, a RAM 803, a storage apparatus 804, and a communication circuit 805. The processor 801 is a computer that includes one or more processing circuits, such as a general-purpose CPU (Central Processing Unit) or an ASIC (Application Specific Integrated Circuit), and performs the overall processing of the device and each of the above-mentioned processes by reading out and executing programs stored in the ROM 802 or the storage apparatus 804. The ROM 802 is a read-only memory that stores information such as programs and various parameters related to the processing executed by the terminal apparatus 101 and the relay devices 121 and 122. The RAM 803 is a random access memory that functions as a workspace when the processor 801 executes a program, and stores temporary information. The storage apparatus 804 is constituted by, for example, a removable external storage apparatus. The communication circuit 805 is constituted, for example, by a circuit for wireless communication of 5G and its successor standards. Note that although one communication circuit 805 is illustrated in FIG. 8, the terminal apparatus 101 and the relay devices 121 and 122 can have a plurality of communication circuits. For example, the terminal apparatus 101 and the relay devices 121 and 122 can have wireless communication circuits for 5G and its successor standards, respectively, and a common antenna for those circuits, and can be configured to be able to execute a sidelink communication function. Note that the terminal apparatus 101 and the relay devices 121 and 122 may each have an antenna suitable for each standard. In addition, the terminal apparatus 101 may further include a communication circuit that complies with a wireless communication standard other than a cellular communication standard, such as a wireless LAN or Bluetooth (registered trademark). In addition, the relay devices 121 and 122 may have a communication circuit or the like for wireless LAN or Bluetooth in addition to or instead of a communication circuit or the like for cellular communication.

FIG. 9 is a diagram illustrating an example of a functional configuration of the terminal apparatus 101. The terminal apparatus 101 includes a first communication unit 901, a second communication unit 902, a virtual antenna control unit 903, and an AI/ML function unit 904. Note that these functions can be implemented, for example, by the processor 801 executing a program stored in the ROM 802 or the storage apparatus 804, or by the communication circuit 805. However, this is an example, and the functions of FIG. 9 may also be realized by another configuration. In addition, the functions shown in FIG. 9 are examples, and the various processes described above may also be realized by function units other than these.

The first communication unit 901 is, for example, a function unit for communicating with the communication function units 131 of the relay devices 121 and 122. The first communication unit 901 has, for example, a sidelink communication function. In addition, the first communication unit 901 may have a Bluetooth communication function or a wireless LAN communication function instead of or in addition to the sidelink communication function. Control communication between the relay devices 121 and 122 is performed using the first communication unit 901. The second communication unit 902 communicates with the base station apparatus 151. Communication of user data and control data with the base station apparatus 151 is performed via the second communication unit 902. When the second communication unit 902 does not use a virtual antenna, it can directly transmit a millimeter-wave signal to the base station apparatus 151, for example. In addition, when the second communication unit 902 uses a virtual antenna, it transmits, for example, a signal in the THz band. The signal in the THz band is converted into a signal in the millimeter-wave band via the relay devices 121 and 122 and transferred to the base station apparatus 151. The second communication unit 902 also receives, for example, the signal in the millimeter-wave band directly transmitted from the base station apparatus 151, or receives a signal converted from the signal in the THz band by the relay devices 121 and 122.

The virtual antenna control unit 903 executes various controls for using the relay devices 121 and 122 as virtual antennas, which are to be performed when using the relay devices 121 and 122 as virtual antennas. The virtual antenna control unit 903 detects a relay device with use of, for example, the first communication unit 901 or the second communication unit 902, and executes connection processing with the relay device to use it as a virtual antenna. In addition, the virtual antenna control unit 903 executes, for example, the above-mentioned various control communications associated with the use of the virtual antenna, via the first communication unit 901 or the second communication unit 902. An AI/ML function unit 904 executes various processes using AI and ML. For example, the AI/ML function unit 904 can perform CSI compression and beam selection as described above. In addition, the AI/ML function unit 904 generates and updates trained models using machine learning as needed. For example, the AI/ML function unit 904 updates the trained model when the trained model becomes unsuitable due to environmental changes or the like. In addition, the AI/ML function unit 904 executes the above-mentioned various control communications associated with the use of AI/ML via, for example, the second communication unit 902. For example, the AI/ML function unit 904 can notify the base station apparatus 151 of a change in the capability information of the terminal apparatus 101 if it becomes necessary to update the trained model related to the compression and decompression of CSI.

FIG. 10 shows an example of a functional configuration of the communication function unit 131 and the control unit 501 (i.e., the parts other than the relay function unit 132) of the relay devices 121 and 122. The parts of the relay devices 121 and 122 other than the relay function unit 132 include a communication unit 1001, a capability information notification unit 1002, and a measurement result notification unit 1003 as their functions. Note that these functions can be implemented, for example, by the processor 801 executing a program stored in the ROM 802 or the storage apparatus 804, or by the communication circuit 805. However, this is an example, and the functions of FIG. 10 may also be realized by another configuration. In addition, the functions shown in FIG. 10 are examples, and the various processes described above may be realized by function units other than these.

The communication unit 1001 has a function corresponding to the first communication unit 901 of the terminal apparatus 101. That is, if the first communication unit 901 performs communication using the sidelink communication function, the communication unit 1001 also has the sidelink communication function. The capability information notification unit 1002 notifies the terminal apparatus 101 of, for example, information on the capabilities of the relay function unit 132 via the communication unit 1001. For example, the capability information notification unit 1002 notifies the terminal apparatus 101 of whether or not it has a relay function unit 132, the frequency band that the relay function unit 132 can use, and the number and configuration of antennas that can be used in the relay function unit 132. The measurement result notification unit 1003 measures the radio quality of a signal received by the relay function unit 132, for example, and notifies the terminal apparatus 101 of the measurement result. The measurement result notification unit 1003 is configured to monitor the reception power of the signal at each antenna of the relay function unit 132, for example, and acquire the radio quality.

As described above, by performing suitable control, the terminal apparatus 101 according to this embodiment can communicate with the base station apparatus 151 with use of a relay device having an RF relay function as an extended antenna. This will enable contribution to Goal 9 of the United Nations’ Sustainable Development Goals (SDGs), which is to “build resilient infrastructure, promote sustainable industrialization, and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A terminal apparatus for connecting to a base station apparatus, comprising:
a determination unit configured to determine a need to change capability information notified to the base station apparatus;
a transmission unit configured to, in response to determining that the capability information needs to be changed, transmit, to the base station apparatus, a signal for transmission of the capability information to the base station apparatus in a state where no inquiry about the capability information is received from the base station apparatus while connection with the base station apparatus is maintained; and
a notification unit configured to notify the base station apparatus of the changed capability information.

2. The terminal apparatus according to claim 1,
wherein the notification unit transmits the signal including the changed capability information to the base station apparatus.

3. The terminal apparatus according to claim 1,
wherein the signal is a signal requesting the base station apparatus to transmit a message inquiring about the capability information, and
the notification unit notifies the base station apparatus of the capability information in response to receiving the message from the base station apparatus.

4. The terminal apparatus according to claim 3,
wherein the signal includes information indicating which item of the capability information is to be changed.

5. The terminal apparatus according to claim 1,
wherein the terminal apparatus uses, as a virtual antenna, a relay device that converts a signal of a first frequency transmitted by the terminal apparatus into a second frequency, amplifies the resulting signal, and relays the amplified signal to the base station apparatus, and converts a signal of the second frequency transmitted by the base station apparatus into the first frequency, amplifies the resulting signal, and relays the amplified signal to the terminal apparatus, and
the determination unit determines that the capability information needs to be changed in response to connection with the relay device used as the virtual antenna being lost, or in response to a new connection with the relay device to be used as the virtual antenna being established.

6. The terminal apparatus according to claim 1,
wherein the terminal apparatus stores a first trained model that compresses channel state information (CSI) between the terminal apparatus and the base station apparatus at a compression rate determined using a predetermined criterion through machine learning in which the CSI is used as input, and a second trained model that decompresses the CSI compressed by the first trained model,
the capability information includes information indicating whether or not compression and decompression of the CSI using the first trained model and the second trained model can be performed, and
the determination unit determines that the capability information needs to be changed if the CSI compressed by the first trained model can no longer be decompressed by the second trained model.

7. The terminal apparatus according to claim 1,
wherein the terminal apparatus stores a trained model that selects which of a plurality of beams formed by the base station apparatus is to be used in communication with the base station apparatus, through machine learning in which a measurement result of a signal sent from the base station apparatus in a portion of the plurality of beams is used as input,
the capability information includes information indicating which of the plurality of beams is to be used in communication with the base station apparatus using the trained model and using the measurement result of the portion of the plurality of beams, and
the determination unit determines that the capability information needs to be changed in a case where a beam selected by inputting a measurement result of a signal sent from the base station apparatus in the portion of the plurality of beams into the trained model no longer matches a beam selected based on measurement results of a signal sent from the base station apparatus in all of the plurality of beams.

8. A control method executed by a terminal apparatus for connecting to a base station apparatus, comprising:
determining a need to change capability information notified to the base station apparatus;
transmitting to the base station apparatus, in response to determining that the capability information needs to be changed, a signal for transmission of the capability information to the base station apparatus in a state where no inquiry about the capability information is received from the base station apparatus while connection with the base station apparatus is maintained; and
notifying the base station apparatus of the changed capability information.

9. A non-transitory computer-readable storage medium that stores a program for causing a computer included in a terminal apparatus for connecting to a base station apparatus to execute a control method including:
determining a need to change capability information notified to the base station apparatus;
transmitting to the base station apparatus, in response to determining that the capability information needs to be changed, a signal for transmission of the capability information to the base station apparatus in a state where no inquiry about the capability information is received from the base station apparatus while connection with the base station apparatus is maintained; and
notifying the base station apparatus of the changed capability information.
